(19) United States
(12) Patent Application Publication
(10) Pub. No.: US 2024/0104592 A1
(43) Pub. Date: Mar. 28, 2024

(54) Technologies for Identifying Geographic Boundaries of Shipping Locations

(71) Applicant: PROJECT44, LLC, Chicago, IL (US)

(72) Inventor: Stephanie Elizabeth Kirmer, Chicago, IL (US)

(21) Appl. No.: 17/948,032

(22) Filed: Sep. 19, 2022

(51) Int. Cl. G06Q 30/02; G06N 3/08

(52) U.S. Cl. CPC G06Q 30/0205; G06N 3/08

(57) ABSTRACT

Systems and methods for analyzing sets of coordinates associated with a physical location to determine a geofence for that physical location are provided. According to certain aspects, sets of coordinates corresponding to vehicle activity in association with the physical location are analyzed to determine a plurality of clusters of coordinates. The plurality of clusters are modified based on certain criteria, and a geofence for the physical location is determined based on the modified clusters. The geofence is used for more accurate data reporting and communication.

### FIELD

The present disclosure is directed to improvements related to identifying geographic boundaries associated with physical locations. More particularly, the present disclosure is directed to platforms and technologies for analyzing tracking data associated with the physical transport of goods and products to determine accurate geofences for physical locations involved in the physical transport of the goods and products.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers (i.e., entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

As commonly understood, a geofence is a virtual perimeter around a point or coordinate(s) corresponding to a physical location. These geofences are defined by a distance or time-of travel radius, are hand drawn, or are generated in some other manner. Currently, entities employ geofences in association with managing shipments, such as to assess whether a certain tracking event has occurred. In particular, tracking events having location coordinates are compared against locations of geofences to assess the statuses of vehicles transporting goods and products, where these statuses are used to update progresses of the shipping jobs, determine estimated times of arrival (ETA), and perform other functionalities. However, these geofences are often not an accurate representation of the physical locations and usage thereof. For example, a given business entity may have multiple physical locations corresponding to multiple facilities in a given vicinity, where the respective geofences for the facilities may overlap one another and lead to tracking statuses being inaccurately determined. Accordingly, use of existing geofences results in inaccurate assessments of shipping jobs, which results in inaccurate reporting and updating of shipping jobs to relevant parties such as business entities.

Accordingly, there is an opportunity for platforms and technologies to leverage various data to effectively and accurately determine geofences for physical locations.

### SUMMARY

In an embodiment, a computer-implemented method of determining a geofence for a location associated with a physical location of a business entity is provided. The method may include: accessing, by one or more processors, sets of coordinates corresponding to a set of vehicles operating within a radius of the location associated with the physical location; analyzing, by the one or more processors, the sets of coordinates to identify a plurality of clusters, each cluster of the plurality of clusters comprising a portion of the sets of coordinates, wherein a first cluster of the plurality of clusters has a first centroid that is nearest to the location associated with the physical location; modifying, by the one or more processors, the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount; and determining, by the one or more processors, the geofence that at least surrounds the plurality of clusters that was modified.

In another embodiment, a system for determining a geofence for a location associated with a physical location of a business entity is provided. The system may include: a memory storing a set of computer-readable instructions; and one or more processors interfaced with the memory. The one or more processors may be configured to execute the set of computer-readable instructions to cause the one or more processors to: access sets of coordinates corresponding to a set of vehicles operating within a radius of the location associated with the physical location, analyze, by the one or more processors, the sets of coordinates to identify a plurality of clusters, each cluster of the plurality of clusters comprising a portion of the sets of coordinates, wherein a first cluster of the plurality of clusters has a first centroid that is nearest to the location associated with the physical location, modify the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount, and determine the geofence that at least surrounds the plurality of clusters that was modified.

Further, in an embodiment, a non-transitory computer-readable storage medium configured to store instructions executable by a computer processor may be provided. The instructions may include: instructions for accessing sets of coordinates corresponding to a set of vehicles operating within a radius of a location associated with a physical location of a business entity; instructions for analyzing the sets of coordinates to identify a plurality of clusters, each cluster of the plurality of clusters comprising a portion of the sets of coordinates, wherein a first cluster of the plurality of clusters has a first centroid that is nearest to the location associated with the physical location; instructions for modifying the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount; and instructions for determining a geofence that at least surrounds the plurality of clusters that was modified.

### BRIEF DESCRIPTION OF THE FIGURES

FIG. 1 depicts an overview of components and entities associated with the systems and methods, in accordance with some embodiments.

FIG. 2A depicts an example signal diagram associated with determining a geofence associated with a physical location, in accordance with some embodiments.

FIG. 2B depicts an exemplary deep learning artificial neural network (DNN) that may be employed by the systems and methods, in accordance with some embodiments.

FIGS. 3A and 3B depict example interfaces associated with different techniques to determine geofences, in accordance with some embodiments.

FIGS. 4A-4D depict example interfaces and charts associated with determining geofences for physical locations, in accordance with some embodiments.

FIG. 5 illustrates an example flow diagram of determining a geofence for a location associated with a physical location of a business entity, in accordance with some embodiments.

FIG. 6 is an example hardware diagram of a server configured to perform various functionalities, in accordance with some embodiments.

### DETAILED DESCRIPTION

The present embodiments may relate to, inter alia, analyzing various data associated with the physical transport of products and goods to determine geofences for physical locations involved in the physical transport of the products and goods. According to certain aspects, in generating the geofences, systems and methods may analyze tracking data indicative of locations of vehicles that are transporting or have transported any products or goods.

Generally, a physical location is a point defined by coordinates, and a geofence is a mathematical or virtual perimeter around this point that may be defined by a distance or time-of-travel radius, or by another manner (e.g., hand drawn or computer-generated). Entities associated with the transport of products or goods may use geofences and corresponding telemetry data to define arrival/departure at stops along a shipping route. In particular, a set of coordinates (e.g., a GPS “ping”) outside a geofence may not be classified as a stop (or other type of event) and a set of coordinates within a geofence may be classified as a stop. The resulting data is used to determine or display accurate data in dashboard, produce accurate ETAs, and other perform other functions. The more accurate a geofence is for a particular location, the more accurate the subsequent analyses, communications, and features.

Conventional systems employ conventionally-generated geofences, which results in inaccurate analyses and communications. For example, conventional geofences respectively corresponding to physical locations may overlap one another, which results in vehicles being inaccurately assigned to physical locations at which the vehicles may not be present or may not have actually stopped. For further example, a geofence that is too large may result in an estimated arrival time that is well in advance of an actual arrive time (e.g., if a vehicle is within a geofence of a facility but is actually overnight parking at that location). Additionally, for example, an inaccurate geofence may result in stops getting triggered out of order, thus impacting any arrival predictions. Moreover, business entity-provided coordinates of physical locations may not align with the actual coordinates of these physical locations, resulting in inaccurate analyses and reporting.

The present embodiments describe generating geofences for physical locations based on an analysis of the locations of vehicles that transport products or goods to and/or from the physical locations. In particular, the embodiments analyze the vehicle locations to determine a set of clusters, each of which contains a portion of the vehicle locations. The embodiments refine the set of clusters according to various determinations and constraints, and generate a geofence based on the area defined by the refined set of clusters. The resulting geofence is an accurate representation of the physical area in which relevant shipping activity (e.g., arrivals, departures, stops, etc.) associated with the physical location occurs.

The systems and methods therefore offer numerous benefits. In particular, the systems and methods employ various data collection and data analysis techniques to effectively and accurately determine geofences associated with physical locations. In this regard, the systems and methods may use data (e.g., vehicle tracking data) associated with the geofences to more effectively and accurately assess shipping activity related to the physical locations, which results in improved and more accurate downstream data analysis and communication. Business entities are afforded the benefit of accurate updates and predictions, and the systems and methods may lead to reduced costs for all involved parties. For example, late fees and early penalties that may be erroneously assessed to drivers due to inaccurate geofences may be reduced or eliminated. It should be appreciated that additional benefits are envisioned.

The present embodiments improve an existing technology, namely logistics technology. Conventional logistics technologies generate or assign a geofence for a physical location that does not accurately reflect shipping activity in association with the physical location, thus resulting in inaccurate data analysis and communication. The present embodiments improve on this technology by accessing (e.g., via tracking devices) tracking data associated with vehicles and reflecting shipping activity by those vehicles in proximity to a physical location. The present embodiments perform a clustering analysis on the tracking data, analyze data associated with the identified clusters, and accordingly generate a geofence that is an accurate representation of the shipping activity by the vehicles. The present embodiments use the resulting geofence to perform more accurate data analyses and communication. The present embodiments may further employ machine learning analyses and techniques to supplement the described cluster analysis and perform additional analyses and predictions, thus offering features that additionally improve on conventional technologies.

The present embodiments do not merely recite the performance of some business practice known from the pre-Internet world (determining a geofence for a physical location) along with the requirement to perform it on the Internet. Instead, the systems and methods incorporate computer networks that enable communications among shipper entities, carrier entities, and data sources such as electronic logging/tracking devices, among other entities and components. Thus, the systems and methods are necessarily rooted in computer technology in order to overcome a problem specifically arising in logistics technologies.

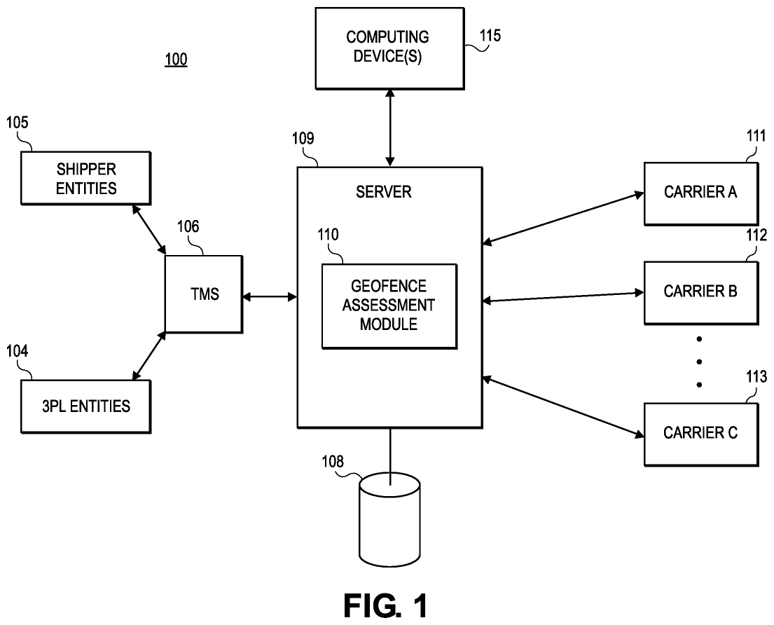

FIG. 1 illustrates an overview of a system 100 of components configured to facilitate the systems and methods. It should be appreciated that the system 100 is merely exemplary and that alternative or additional components are envisioned.

As illustrated in FIG. 1, the system 100 includes a set of shipper entities 105 and a set of 3PL entities 104. Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various amounts of the shipper entities 105 are envisioned.

Each of the 3PL entities 104 may be a third-party provider that the set of shipper entities 105 may use to outsource certain elements associated with handling and managing the transportation of the physical goods. In some embodiments, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to embodiments, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to embodiments, the TMS 106 may support specific and particular communication capabilities with the other entities of the system 100. In particular, the TMS 106 may support communication with the other entities via different components and protocols.

As illustrated in FIG. 1, the system 100 may include a server 109 that may interface and communicate with at least the TMS 106, the set of carrier entities 111, 112, 113, and a set of computing devices 115. The server 109 may include any combination or hardware and software components, and may be associated with any type of entity or individual.

According to embodiments, the computing device(s) 115 may be associated with a company, customer, corporation, business, entity, individual, group of individuals, and/or the like (as referred to herein, a “business entity”) that may have one or more physical (“brick and mortar”) facilities, stores, warehouses, distribution centers, and/or the like (generally, a physical location), to which products and/or goods are shipped, or via which products and/or goods pass through during shipment. For example, a physical location may be a store that sells or offers a combination of physical goods and/or services, or may be a distribution center to which manufacturers deliver products and from which the products are delivered to consumers or end recipients. According to embodiments, a given physical location may have associated a location in the form of a set of coordinates (e.g., GPS coordinates, lat/long coordinates, etc.), where the location may be identified or assigned by the business entity or determined from available data (e.g., an analysis of a map). The server 109 may access or retrieve the location of a given physical location from the computing device(s) 115, or from another source.

A given computing device 115 (and a corresponding business entity) may or may not be associated with a given shipper entity 105. Further, one or more of the set of carrier entities 111, 112, 113 may have a vehicle(s) that transports a set of physical goods to the physical location(s) of a given business entity. The vehicle(s) may consistently or periodically generate a set of coordinates (e.g., GPS coordinates, lat/long coordinates, etc.) indicative of a physical location of the vehicle(s), where each set of coordinates may have an associated timestamp. In embodiments, a location module of a given vehicle (not shown in FIG. 1) may transmit generated sets of coordinates and their timestamps to the server 109 via a network connection. The server 109 may access the set(s) of coordinates directly from the location module(s) of the vehicle(s), or may access the set(s) of coordinates from another source (e.g., a database associated with the corresponding carrier entity). For example, a database associated with a corresponding carrier entity may accumulate sets of coordinates associated with a set of vehicles over a time period, and the server 109 may retrieve these sets of coordinates from the database.

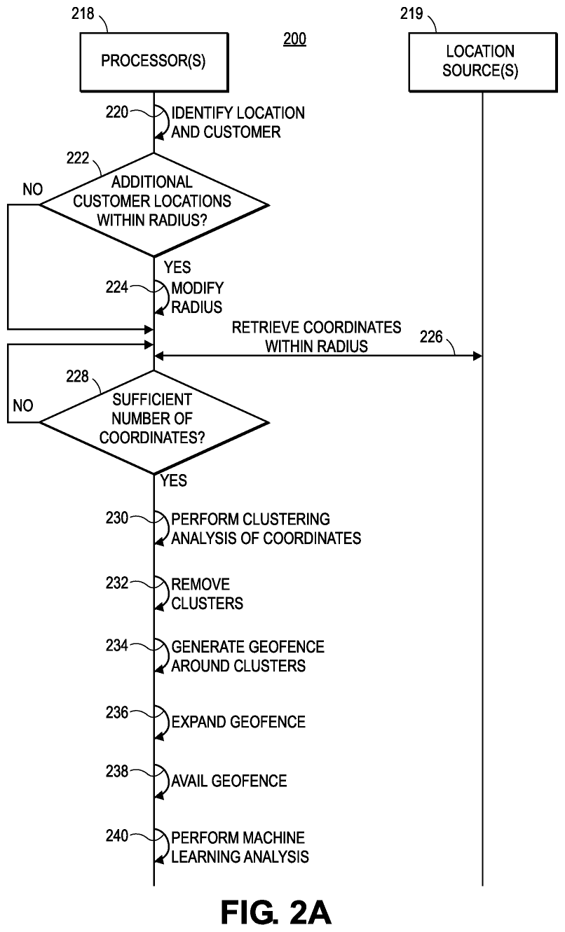

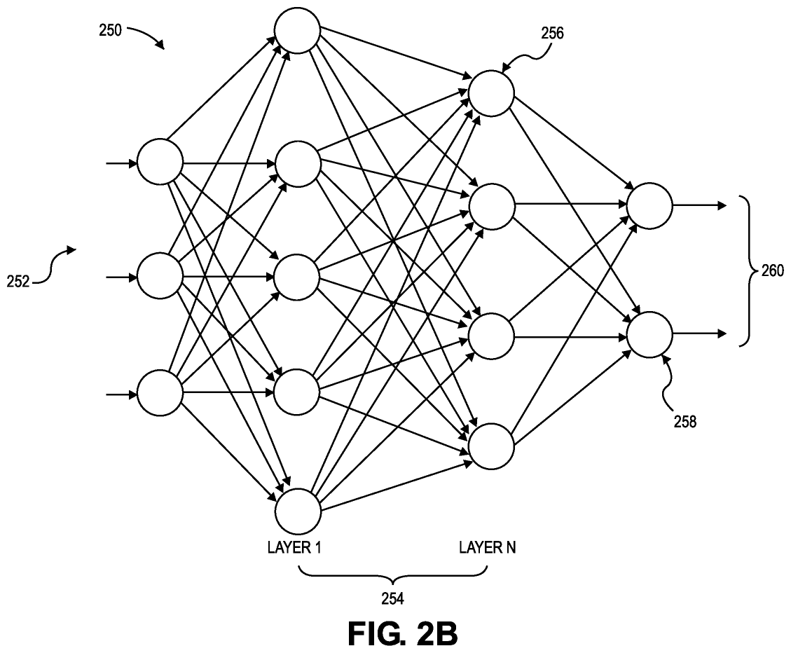

According to embodiments, the server 109 may support execution of a geofence assessment module 110. As understood, a geofence may be a virtual perimeter that corresponds to a real-world geographic area. According to embodiments, the geofence assessment module 110 may receive various data associated with the transportation of a set of products, goods, materials, and/or the like, analyze the received data, and calculate and/or generate a geofence associated with a particular business entity or a physical location associated with a business entity. Accordingly, a given geofence may be a virtual perimeter that may encompass or surround at least a portion (or all) of a given physical location associated with a given business entity. In embodiments, the geofence assessment module 110 (or more generally, the server 109) may support and facilitate various machine learning techniques to determine geofences for physical locations. These functionalities are further described with respect to FIG. 2A.

The geofence assessment module 110 (or more generally, the server 109) may interface with a database 108 or other type of memory configured to store data accessible by the geofence assessment module 110 (or the server 109). In embodiments, the database 108 may store location data associated with physical locations, sets of coordinates for vehicles that are transporting or did transport physical goods across various timeframes or ranges of timeframes, and/or other data.

The set of computing devices 115 may enable a set of users access to a dashboard, interface, or the like that may indicate determined geofences for physical locations, as determined by the geofence assessment module 110. In embodiments, the set of computing devices 115 may be associated with one or more of the shipper entities 105. Accordingly, the set of computing devices 115 may interface with the shipper entities 105 and/or other components.

Although FIG. 1 depicts the server 109 in communication with the TMS 106 and the set of carrier entities 111, 112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105 and the set of carrier entities 111, 112, 113). In another implementation, either the TMS 106 or the 3PL entity 104 may be combined with the server 109 as a single entity capable of performing the respective functionalities.

Although not depicted in FIG. 1, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the geofence assessment module 110) via an Internet connection.

It should be appreciated that the components and entities of the system 100 may include and support various combinations of hardware and software components capable of facilitating various of the functionalities of the systems and methods. For example, the components and entities of the system 100 may generally support one or more computer processors, communication modules (e.g., transceivers), memories, and/or other components.

FIG. 2A depicts a signal diagram 200 including various functionalities associated with the described embodiments. The signal diagram 200 includes a processor(s) 218 and a location source(s) 219. According to embodiments, the processor(s) 218 may be incorporated as part of a server (such as the server 109 as discussed with respect to FIG. 1). Further, the location source(s) 219 may be a set of location modules respectively disposed in a set of vehicles, or may be a database or other type of data source that compiles location data accumulated from a set of location modules respectively disposed in a set of vehicles, or from another source(s) or device(s).

The signal diagram 200 may begin when the processor 218 identifies (220) a location and a business entity, or otherwise receives a request from a business entity identifying a location. According to embodiments, the business entity may be an entity having one or more physical locations, where the location identified in (220) may be a location associated with one of the physical locations. It should be appreciated that the location may be provided by the business entity and may be referred to as a centroid having associated a set of coordinates. In embodiments, the processor(s) 218 may determine the location from various available data/information, such as map data, address information, and/or other information. Generally, the location for a physical location may be in the form of a set of coordinates (e.g., GPS coordinates or the like). In embodiments, the location may have an associated radius of a given distance which may extend radially from the location (or extend in another manner), where the given distance may be a default distance. It should be appreciated that the size of the radius may be a default value (e.g., 2 km) or may be configurable.

The processor(s) 218 may determine whether there are additional physical locations associated with the business entity within the given radius of the location. For example, the business entity may have multiple brick-and-mortar locations/stores within the given radius of the location. If there are additional physical locations within the given radius (or the number of additional physical locations at least meets a threshold value) (“YES”), the processor(s) 218 may modify (224) the radius. In embodiments, the processor(s) 218 may modify the radius to be half the distance to the physical location closest to the location of the subject (original) physical location. It should be appreciated that the processor(s) 218 may modify the radius to be other distances or according to other calculations. For example, the more additional physical locations there are within a given radius, the more the processor(s) 218 may reduce the given radius. If there are not additional physical locations within the given radius (or the number of additional physical locations does not meet a threshold value) (“NO”), processing may proceed to (226).

At (226), the processor(s) 218 may retrieve, from the location source(s) 219, sets of coordinates within the radius. In embodiments, the sets of coordinates may be locations of a set of vehicles that are transporting or have transported a set of products for the business entity to any identified physical location of the business entity. The set(s) of coordinates may be real-time or near-real time data corresponding to a location(s) of a set of vehicles as the set of products are transported, or may be historical location data that has been captured and/or accumulated over a given timeframe (e.g., over the most recent or prior month, year, etc.).

The processor(s) 218 may determine (228) whether there is a sufficient number of the sets of coordinates, where the sufficient number may be a default value (e.g., 100) or may be configurable. Generally, the analyses described with respect to the signal diagram 200 may result in more accurate data with a greater amount of sets of coordinates. If there is not a sufficient number of the sets of coordinates (“NO”), processing may return to (226) or proceed to other functionality. If there is a sufficient number of the sets of coordinates (“YES”), processing may proceed to (230).

At (230), the processor(s) 218 may performing a clustering analysis of the coordinates. For example, the processor(s) 218 may perform a density-based spatial clustering of applications with noise (DBSCAN) algorithm, or another algorithm, calculation, or the like. In embodiments, the processor(s) 218 may initially define ε as a size of the radius of a neighborhood with respect to some point, and a parameter (“min_samples”) representative of the number of points required for a point/coordinate to be a “core” point/coordinate (i.e., (directly-) reachable point/coordinate). The default value for ε may be 0.0005, or another value, and min_samples may be five (5), or another value. Further, the processor(s) 218 may define a minimum allowed cluster size (e.g., ten (10), or another value).

In performing the clustering analysis, the processor(s) 218 may define a point p as a core point if at least min_samples points are within distance ε of it (including p). Further, a point q is directly reachable from p if point q is within distance ε from core point p, where, in some implementations, points are only said to be directly reachable from core points. Additionally, a point q is reachable from p if there is a path p₁, . . . , pₙ with p₁=p and pₙ=q, where each pᵢ₊₁ is directly reachable from pᵢ (note that this implies that the initial point and all points on the path must be core points, with the possible exception of q). Any core points may represent building blocks of clusters. Moreover, all points not reachable from any other point are “outliers”. It should be appreciated that the processor(s) 218 may employ different techniques, calculations, algorithms, or the like in determining the clusters and the core points.

Of the clusters determined in (230), one of the clusters is deemed to be nearest to the location/centroid identified in (220). Further, one (or more) of the clusters may be identified as containing the most points/coordinates of the clusters. Further, each of the determined clusters may have a centroid that may be defined as the center point of that given cluster. At (232), the processor(s) 218 may remove any of the clusters that are outside a certain distance (as measured from the respective centroids of the clusters) from the cluster nearest to the location/centroid identified in (220). Additionally or alternatively, the processor(s) 218 may remove any of the clusters that are outside a certain distance (as measured from the respective centroids of the clusters) from its nearest cluster. It should be appreciated that the certain distance may be a default value (e.g., 400 m) or may be configurable.

Further, at (232), the processor(s) 218 may remove any clusters containing an amount of points/coordinates less than a given value. For example, the given value may be a default or configurable threshold (e.g., five (5)), or may be equal to a percentage (e.g., 20%) of the number of points/coordinates contained in the cluster containing the most points/coordinates. It should be appreciated that multiple values may be used in the determination of whether to remove clusters (e.g., removing any cluster having less than seven (7) points/coordinates or fewer than 25% of the number of points/coordinates contained in the cluster containing the most points/coordinates).

The processor(s) 218 may generate (234) a geofence in association with the cluster(s) that remains after removing any clusters in (232). In embodiments, the processor(s) 218 may generate the geofence as a convex hull, or another shape, where the geofence may surround the remaining cluster(s). That is, the geofence may be shaped to surround any points/coordinates contained in the remaining cluster(s). It should be appreciated that the processor(s) 218 may use any algorithm, technique, calculation, or the like in generating the geofence.

The processor(s) 218 may expand (236) the geofence that was generated in (234). In particular, the processor(s) 218 may add a “buffer zone” around the generated geofence to expand the generated geofence. For example, the processor(s) 218 may expand the generated geofence by fifty (50) meters (or other distances) in all directions.

At (238), the processor(s) 218 may avail the geofence for access by one or more computing devices. In particular, a user of the one or more computing devices may use the one or more computing devices to review the geofence and facilitate various functionalities associated with the geofence. For example, the user may update information associated with the business entity, such as address information, shipments associated with the business entity, and/or the like. Further, the user may use the geofence to streamline subsequent transportation of products associated with the business entity. It should be appreciated that other functionalities associated with using and analyzing the geofence are envisioned.

At (240), the processor(s) 218 may perform a machine learning analysis on any resulting data, and/or may other perform any additional analysis on the data. According to embodiments, the retrieved coordinates associated with a physical location (e.g., the coordinates retrieved in (226) and the generated geofence for the physical location may serve as a set of labeled training data. The processor(s) 218 (or another computing device(s)) may train a machine learning model using this set of labeled training data. Further, for a given physical location, the processor(s) 218 (or another computing device(s)) may input sets of coordinates associated with that physical location into the trained machine learning model, which may output coordinates/boundaries for a geofence for the physical location. The processor(s) 218 (or another computing device(s)) may update the machine learning model as new outputs are generated, in response to an output being modified or adjusted, with new training data, or in response to other determinations or triggers.

It should be appreciated that various machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like, are envisioned. The data associated with these machine learning techniques, such as training data and machine learning model data, may be stored in one or more databases (such as the database 108 as described with respect to FIG. 1).

FIG. 2B depicts an exemplary deep learning artificial neural network (DNN) 250, which may be used in conjunction with the machine learning techniques as discussed herein. The DNN 250 may be trained and/or operated by the server 109 of FIG. 1, for example. The DNN 250 may include a plurality of layers, each of which may include any number of respective neurons, or nodes.

The DNN 250 may include an input layer 252, one or more hidden layers 254, and an output layer 258. Each of the layers in the DNN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of DNNs are possible.

The input layer 252 may correspond to a large number of input parameters (e.g., one million inputs), in some embodiments, and may be analyzed serially or in parallel. Further, various neurons and/or neuron connections within the DNN may be initialized with any number of weights and/or other training parameters. Each of the neurons in the hidden layers 254 may analyze one or more of the input parameters from the input layer 252, and/or one or more outputs from a previous one or more of the hidden layers 254, to generate a decision 260 or other output. The output layer 258 may generate the decision 260 or more outputs, each indicating a prediction or an expected value. The number of input neurons may be stored as a predetermined value, and used to initialize a network for training.

In some embodiments and/or scenarios, the output layer 258 may include only a single output 260. For example, a neuron may correspond to one of the neurons in a hidden layer 256. Each of the inputs to the neuron may be weighted according to a set of weights W1 through Wi, determined during the training process (for example, if the neural network is a recurrent neural network) and then applied to a node that performs an operation α. The operation α may include computing a sum, a difference, a multiple, or a different operation. In some embodiments weights are not determined for some inputs. In some embodiments, neurons of weight below a threshold value may be discarded/ignored. The sum of the weighted inputs, r1, may be input to a function which may represent any suitable functional operation on r1. The output of the function may be provided to a number of neurons of a previous/subsequent layer or as an output 260 of the DNN. In some embodiments, the DNN may include one or more convolutional neural network (CNN) layers.

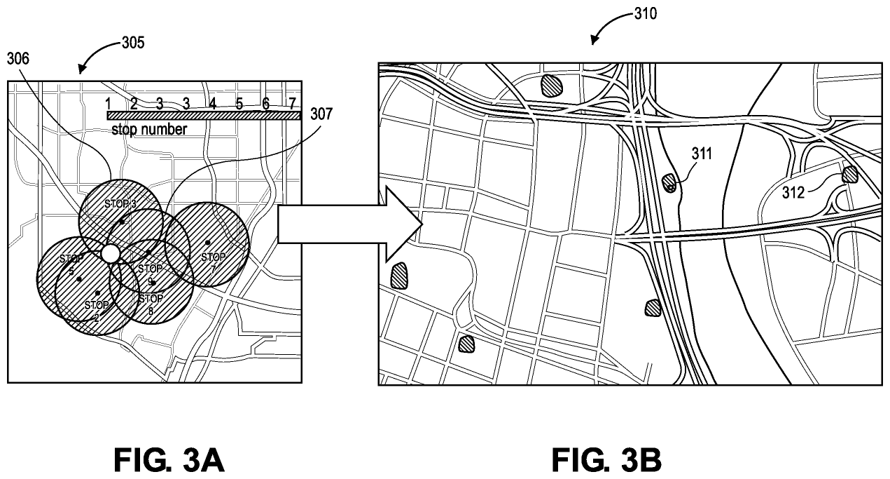

FIGS. 3A and 3B are example mapping interfaces depicting different types of geofences. In particular, FIG. 3A is a mapping interface 305 depicting geofences used in conventional shipping management technologies. The mapping interface 305 includes a set of geofences, including geofences 306 and 307, each of which corresponds to a stop associated with a physical location. As depicted in FIG. 3A, at least some of the set of geofences overlap one another. As a result, if an accessed set of coordinates for a vehicle is within multiple geofences (e.g., within each of 306 and 307), an electronic device is not able to determine at which stop that vehicle is actually present.

FIG. 3B depicts a mapping interface 310 depicting geofences generated in accordance with the described systems and methods. The geofences included in the mapping interface 310 do not overlap one another and are more specific to the corresponding stops/locations than the geofences included in the mapping interface 305 of FIG. 3A. For example, geofences 311 and 312 are generated to encompass or surround areas that are more specific to the geographic features of the corresponding physical locations.

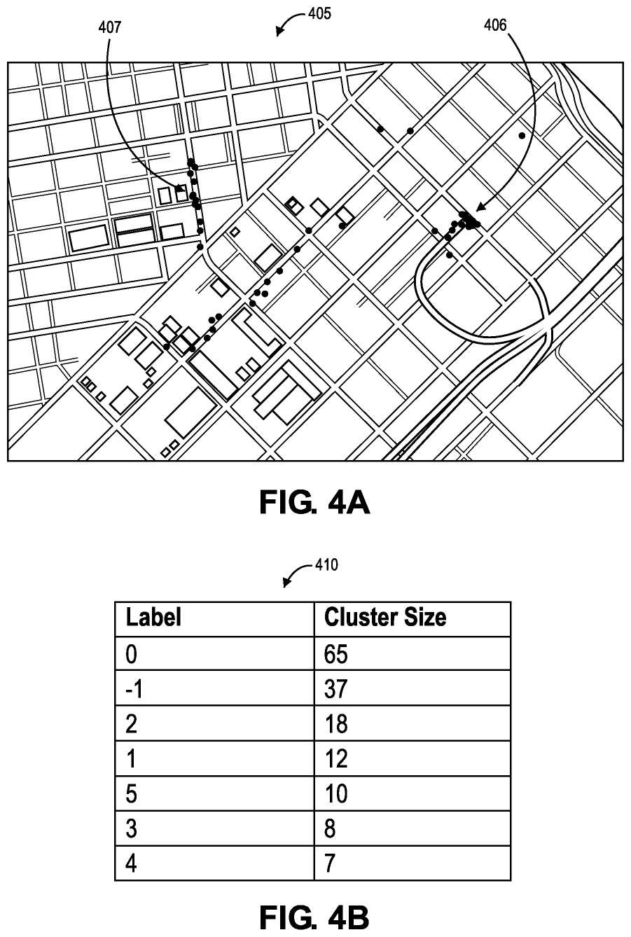

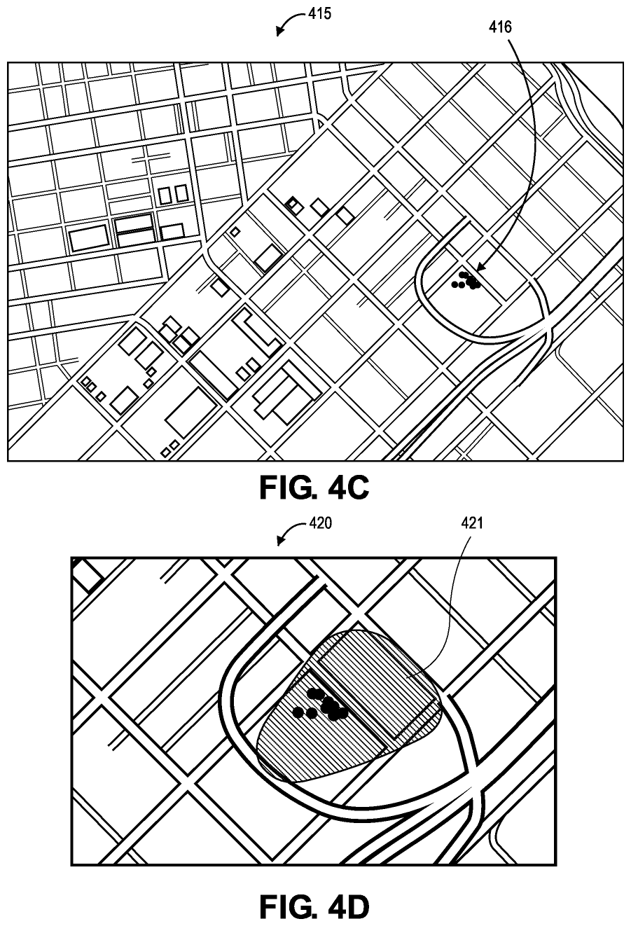

FIGS. 4A-4D depict example mapping interfaces and charts associated with analyzing sets of coordinates associated with a physical location and determining a geofence for the physical location. It should be appreciated that the mapping interfaces and charts of FIGS. 4A-4D are merely examples and that additional or alternative content and/or information.

FIG. 4A depicts a mapping interface 405 depicting sets of coordinates (“pings”) at various locations of the interface 405. Generally, the sets of coordinates may correspond to locations of vehicles participating in shipping activity in association with the physical location. The interface 405 includes a first grouping of coordinates 406 and a second grouping of coordinates 407, among other groupings and sets of coordinates. Based on the locations of the sets of coordinates, an electronic device may determine different clusters of coordinates using the techniques as discussed herein.

FIG. 4B depicts a chart 410 listing a set of clusters, and in particular a label and a size for each of the cluster in the set of clusters. For example, the cluster with the label “0” has sixty-five (65) coordinates included therein. The electronic device may determine, based on the data in the chart 410, which clusters to remove, where the electronic device may use the remaining clusters to determine the geofence. The cluster with the label “−1” may represent outlier coordinates and may be automatically removed. Additionally, in the example depicted, the electronic device may remove any clusters that do not have at least 20% of the number of coordinates that are included in the cluster having the most coordinates. In particular, the cluster with the label “0” has 65 coordinates where 20% of 65 is thirteen (13). The only other cluster having at least 13 coordinates is cluster “2”, so the electronic device may remove clusters “1”, “5”, “3”, and “4”.

FIG. 4C depicts a mapping interface 415 that depicts a set of clusters (and their corresponding sets of coordinates) that remain after the electronic device removes any clusters to not meet established criteria. In particular, the interface 415 includes at least one cluster 416 that includes corresponding sets of coordinates.

FIG. 4D depicts a mapping interface 420 that depicts a zoomed-in area around the cluster(s) 416 of FIG. 4C. The interface 420 of FIG. 4D includes a geofence 421 that the electronic device may generate based on the coordinates included in the cluster(s) 416 of FIG. 4C. As depicted in FIG. 4D, the geofence 421 at least surrounds or encompasses the coordinates included in the cluster(s) 416, where the geofence 421 may be expanded by a defined distance (e.g., 50 meters).

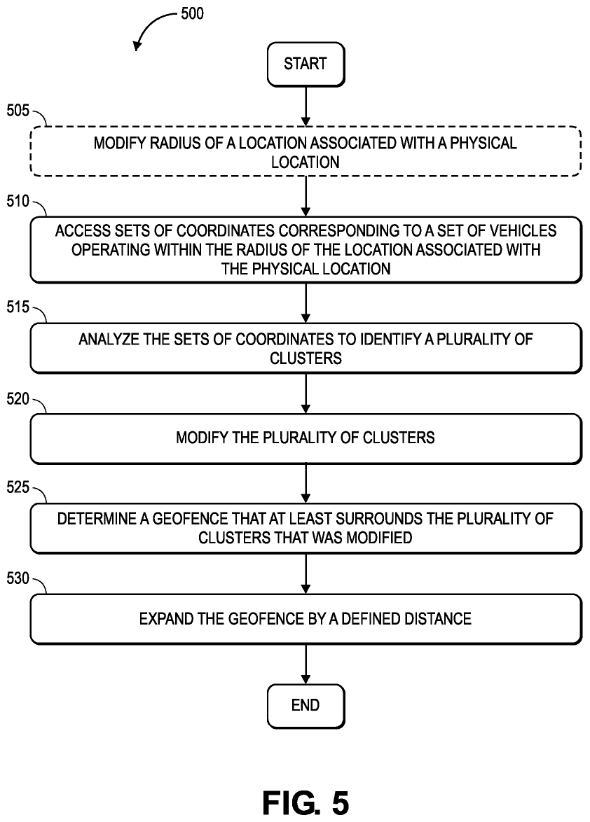

FIG. 5 depicts is a block diagram of an example method 500 of determining a geofence for a location associated with a physical location of a business entity. The method 500 may be facilitated by an electronic device (such as the server 109 as depicted in FIG. 1A). In embodiments, the electronic device may communicate with a set of data sources, a set of location tracking devices, and/or a set of computing devices. Further, in embodiments, the location may be defined for the physical location, where the location may have a radius of a default or specified size.

The method 500 may begin when the electronic device optionally modifies (block 505) the radius of the location associated with the physical location. In embodiments, the electronic device may determine that there is a set of additional physical locations of the business entity within the radius of the location and, in response, may reduce the radius of the location (e.g., to be half its original size).

The electronic device may access (block 510) sets of coordinates corresponding to a set of vehicles operating within the radius of the location associated with the physical location. In embodiments, the electronic device may receive, from a set of location tracking devices respectively disposed within the set of vehicles, the sets of coordinates.

The electronic device may analyze (block 515) the sets of coordinates to identify a plurality of clusters. In embodiments, the electronic device may determine that an amount of the sets of coordinates at least meets an additional threshold value and, in response, analyze the sets of coordinates to identify the plurality of clusters. Further, in embodiments, each cluster of the plurality of clusters may comprise a portion of the sets of coordinates, and wherein a first cluster of the plurality of clusters may have a first centroid that is nearest to the location associated with the physical location.

The electronic device may modify (block 520) the plurality of clusters. In embodiments, the electronic device may remove, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount. Further, in embodiments, the threshold amount may be equal to a percentage amount of the sets of coordinates included in a cluster of the plurality of clusters having the largest amount of the sets of coordinates.

The electronic device may determine (block 525) a geofence that at least surrounds the plurality of clusters that was modified. Further, the electronic device may expand (block 530) the geofence by a defined distance (e.g., fifty (50) meters).

In embodiments, the electronic device may support machine learning technologies associated with the determination of geofences. In particular, the electronic device may train a machine learning model using a training dataset comprising the sets of coordinates and the geofence, store the machine learning model in memory, access additional sets of coordinates corresponding to an additional set of vehicles operating within an additional radius of an additional location associated with an additional physical location, analyze, using the machine learning model, the additional sets of coordinates, and based on the analyzing, output, by the machine learning model, an additional geofence associated with the additional physical location.

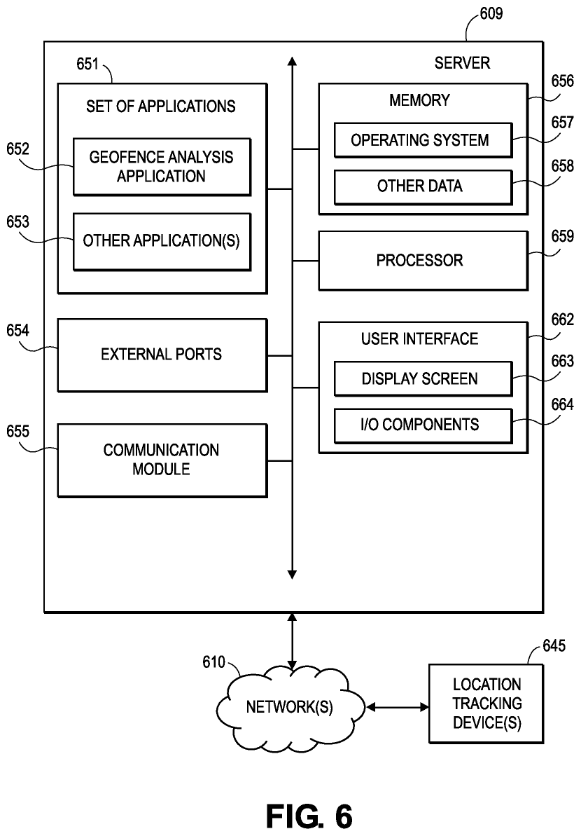

FIG. 6 illustrates a hardware diagram of an example server 609 (e.g., the server 109 as described with respect to FIG. 1), in which the functionalities as discussed herein may be implemented.

As illustrated in FIG. 6, the server 609 may include a processor 659 as well as a memory 656. The memory 656 may store an operating system 657 capable of facilitating the functionalities as discussed herein as well as a set of applications 651 (i.e., machine readable instructions). For example, one of the set of applications 651 may be a geofence analysis application 652, such as to analyze sets of coordinates associated with a physical location and determine a geofence for the physical location based on the sets of coordinates. It should be appreciated that one or more other applications 653 are envisioned.

The processor 659 may interface with the memory 656 to execute the operating system 657 and the set of applications 651. According to some embodiments, the memory 656 may also store other data 658, such as machine learning model data (including training data), various location data, information associated with physical locations, and/or other data. The memory 656 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 609 may further include a communication module 655 configured to communicate data via one or more networks 610. According to some embodiments, the communication module 655 may include one or more transceivers (e.g., WAN, WWAN, WLAN, and/or WPAN transceivers) functioning in accordance with IEEE standards, 3GPP standards, or other standards, and configured to receive and transmit data via one or more external ports 654. In particular, the communication module 655 of the server 609 may interface with a set of location tracking device(s) 645 (and/or additional devices) via the network(s) 610 and the set of external ports 654.

The server 609 may further include a user interface 662 configured to present information to a user and/or receive inputs from the user. As shown in FIG. 6, the user interface 662 may include a display screen 663 and I/O components 664 (e.g., ports, capacitive or resistive touch sensitive input panels, keys, buttons, lights, LEDs, external or built in keyboard). According to some embodiments, the user may access the server 609 via the user interface 662 to review information, make selections, and/or perform other functions.

In some embodiments, the server 609 may perform the functionalities as discussed herein as part of a “cloud” network or may otherwise communicate with other hardware or software components within the cloud to send, retrieve, or otherwise analyze data. Further, in embodiments, the server 609 may support operation of a desktop or mobile application which may enable remote administration of the cloud data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 659 (e.g., working in connection with the operating system 657) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate or additional embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of determining a geofence for a location associated with a physical location of a business entity, the method comprising:
accessing, by one or more processors, sets of coordinates corresponding to a set of vehicles operating within a radius of the location associated with the physical location;
analyzing, by the one or more processors, the sets of coordinates to identify a plurality of clusters, each cluster of the plurality of clusters comprising a portion of the sets of coordinates, wherein a first cluster of the plurality of clusters has a first centroid that is nearest to the location associated with the physical location;
modifying, by the one or more processors, the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount; and
determining, by the one or more processors, the geofence that at least surrounds the plurality of clusters that was modified.

2. The computer-implemented method of claim 1, wherein accessing the sets of coordinates comprises:
determining that there is a set of additional physical locations of the business entity within the radius of the location associated with the physical location;
in response to determining that there is the set of additional physical locations, reducing the radius of the location associated with the physical location; and
accessing the sets of coordinates corresponding to the set of vehicles operating within the radius that was reduced.

3. The computer-implemented method of claim 1, wherein accessing the sets of coordinates comprises:
receiving, from a set of location tracking devices respectively disposed within the set of vehicles, the sets of coordinates.

4. The computer-implemented method of claim 1, wherein analyzing the sets of coordinates to identify the plurality of clusters comprises:
determining, by the one or more processors, that an amount of the sets of coordinates at least meets an additional threshold value; and
in response to determining that the amount of the sets of coordinates at least meets the additional threshold value, analyzing, by the one or more processors, the sets of coordinates to identify the plurality of clusters.

5. The computer-implemented method of claim 1, further comprising:
expanding, by the one or more processors, the geofence by a defined distance.

6. The computer-implemented method of claim 1, wherein the threshold amount is equal to a percentage amount of the sets of coordinates included in a cluster of the plurality of clusters having the largest amount of the sets of coordinates.

7. The computer-implemented method of claim 1, further comprising:
training, by the one or more processors, a machine learning model using a training dataset comprising the sets of coordinates and the geofence;
storing the machine learning model in memory;
accessing additional sets of coordinates corresponding to an additional set of vehicles operating within an additional radius of an additional location associated with an additional physical location;
analyzing, by the one or more processors using the machine learning model, the additional sets of coordinates; and
based on the analyzing, outputting, by the machine learning model, an additional geofence associated with the additional physical location.

8. A system for determining a geofence for a location associated with a physical location of a business entity, comprising:
a memory storing a set of computer-readable instructions; and
one or more processors interfaced with the memory, and configured to execute the set of computer-readable instructions to cause the one or more processors to:
access sets of coordinates corresponding to a set of vehicles operating within a radius of the location associated with the physical location,
analyze, by the one or more processors, the sets of coordinates to identify a plurality of clusters, each cluster of the plurality of clusters comprising a portion of the sets of coordinates, wherein a first cluster of the plurality of clusters has a first centroid that is nearest to the location associated with the physical location,
modify the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount, and
determine the geofence that at least surrounds the plurality of clusters that was modified.

9. The system of claim 8, wherein to access the sets of coordinates, the one or more processors is configured to execute the set of computer-readable instructions to cause the one or more processors to:
determine that there is a set of additional physical locations of the business entity within the radius of the location associated with the physical location,
in response to determining that there is the set of additional physical locations, reduce the radius of the location associated with the physical location, and
access the sets of coordinates corresponding to the set of vehicles operating within the radius that was reduced.

10. The system of claim 8, wherein to access the sets of coordinates, the one or more processors is configured to execute the set of computer-readable instructions to cause the one or more processors to:
receive, from a set of location tracking devices respectively disposed within the set of vehicles, the sets of coordinates.

11. The system of claim 8, wherein to analyze the sets of coordinates to identify the plurality of clusters, the one or more processors is configured to execute the set of computer-readable instructions to cause the one or more processors to:
determine that an amount of the sets of coordinates at least meets an additional threshold value, and
in response to determining that the amount of the sets of coordinates at least meets the additional threshold value, analyze the sets of coordinates to identify the plurality of clusters.

12. The system of claim 8, wherein the one or more processors is configured to execute the set of computer-readable instructions to further cause the one or more processors to:
expand the geofence by a defined distance.

13. The system of claim 8, wherein the threshold amount is equal to a percentage amount of the sets of coordinates included in a cluster of the plurality of clusters having the largest amount of the sets of coordinates.

14. The system of claim 8, wherein the memory stores a machine learning model, and wherein the one or more processors is configured to execute the set of computer-readable instructions to further cause the one or more processors to:
train the machine learning model using a training dataset comprising the sets of coordinates and the geofence,
access additional sets of coordinates corresponding to an additional set of vehicles operating within an additional radius of an additional location associated with an additional physical location,
analyze, using the machine learning model, the additional sets of coordinates, and
based on the analyzing, output, by the machine learning model, an additional geofence associated with the additional physical location.

15. A non-transitory computer-readable storage medium configured to store instructions executable by a computer processor, the instructions comprising:
instructions for accessing sets of coordinates corresponding to a set of vehicles operating within a radius of a location associated with a physical location of a business entity;
instructions for analyzing the sets of coordinates to identify a plurality of clusters, each cluster of the plurality of clusters comprising a portion of the sets of coordinates, wherein a first cluster of the plurality of clusters has a first centroid that is nearest to the location associated with the physical location;
instructions for modifying the plurality of clusters, including removing, from the plurality of clusters, (i) a first portion of the plurality of clusters each of which having a centroid that is at least a threshold distance away from the first centroid of the first cluster, and (ii) a second portion of the plurality of clusters each of which having an amount of the sets of coordinates that is less than a threshold amount; and
instructions for determining a geofence that at least surrounds the plurality of clusters that was modified.

16. The non-transitory computer-readable storage medium of claim 15, wherein the instructions for accessing the sets of coordinates comprise:
instructions for determining that there is a set of additional physical locations of the business entity within the radius of the location associated with the physical store;
instructions for, in response to determining that there is the set of additional physical stores, reducing the radius of the location associated with the physical location; and
instructions for accessing the sets of coordinates corresponding to the set of vehicles operating within the radius that was reduced.

17. The non-transitory computer-readable storage medium of claim 15, wherein the instructions for accessing the sets of coordinates comprise:
instructions for receiving, from a set of location tracking devices respectively disposed within the set of vehicles, the sets of coordinates.

18. The non-transitory computer-readable storage medium of claim 15, wherein the instructions for analyzing the sets of coordinates to identify the plurality of clusters comprise:
instructions for determining that an amount of the sets of coordinates at least meets an additional threshold value; and
instructions for, in response to determining that the amount of the sets of coordinates at least meets the additional threshold value, analyzing the sets of coordinates to identify the plurality of clusters.

19. The non-transitory computer-readable storage medium of claim 15, wherein the instructions further comprise:
instructions for expanding the geofence by a defined distance.

20. The non-transitory computer-readable storage medium of claim 15, wherein the threshold amount is equal to a percentage amount of the sets of coordinates included in a cluster of the plurality of clusters having the largest amount of the sets of coordinates.
